(19) United States
(12) Patent Application Publication
(10) Pub. No.: US 2008/0015084 A1
(43) Pub. Date: Jan. 17, 2008

(54) LONGITUDINAL MOTION ACTUATOR

(76) Inventors: Eiji MAYUMI, Matsudo-shi (JP); Takashi USHIKU, Matsudo-shi (JP)

Correspondence Address: MCGLEW & TUTTLE, PC, P.O. BOX 9227, SCARBOROUGH STATION, SCARBOROUGH, NY, 10510-9227, US

(21) Appl. No.: 11/775,397

(22) Filed: Jul. 10, 2007

(30) Foreign Application Priority Data
Jul. 11, 2006 (JP) 2006-190233

(51) Int. Cl. F16H 13/04

(52) U.S. Cl. 476/67; 74/112

(57) ABSTRACT

In a longitudinal motion actuator, one pinion is fixed to a motor output shaft, and a plurality of transmission mechanisms having the same configuration are provided. Each of transmission mechanisms is configured so that both ends of a lead screw to which a gear engaging with the pinion is fixed are rotatably supported by bearings. A movable nut provided with a plurality of threaded holes engaging with thread grooves in the lead screws of the plurality of transmission mechanisms is provided, and when the motor is rotated, the lead screws are rotated in the same direction via the pinion and the gear, by which the movable nut is driven longitudinally.

### BACKGROUND OF THE INVENTION

1. Field of the Invention

The present invention relates to a longitudinal motion actuator that converts the rotation of a motor into longitudinal motion and outputs the motion and is used for electrical applications etc. for an automobile.

2. Description of the Related Art

FIG. 4 is a schematic view showing the configuration of a conventional longitudinal motion actuator (refer to Japanese Utility Model Laid-Open No. 63-195152). The longitudinal motion actuator shown in FIG. 4 has first and second transmission mechanisms each consisting of a lead screw and a gear. The first transmission mechanism is connected to the output shaft of a motor at the end part thereof. By engaging the gears provided on both of the transmission mechanisms with each other, when the first transmission mechanism is rotated by the driving force of the motor, the driving force is transmitted to the second transmission mechanism via the gears, whereby the second transmission mechanism can be rotated. The first transmission mechanism connected to the output shaft of the motor is rotated in the same direction as the direction of motor rotation, whereas the second transmission mechanism to which the driving force is transmitted via the gears is rotated in the direction opposite to the direction of rotation of the first transmission mechanism. Thereby, an output mechanism connected between both of the transmission mechanisms can be driven in the thrust direction.

For the longitudinal motion actuator shown in FIG. 4, since the first transmission mechanism is directly connected to the output shaft of the motor in this manner, in order to obtain a high output, the output of the motor must be increased. The connection between the transmission mechanisms is accomplished via the gears provided on both of the transmission mechanisms. If the output of the motor is increased to obtain a high output, a stress applied to the gear tooth also increases, which also increases the possibility of troubles such as a broken tooth. A reaction force (running-off force) in the direction of rotation is applied to the two gears, and at the same time, a reaction force with respect to the gear of output mechanism is applied to the two lead screws, so that a radial load in the transverse direction is applied to bearings for supporting the transmission mechanisms. Therefore, a problem of decreased durability of bearings may occur. Also, each of the first and second transmission mechanisms is formed by different parts, so that in terms of cost, the mechanisms are high in cost because it is difficult to make the parts thereof common.

### SUMMARY OF THE INVENTION

The present invention has been made to solve the above-described problems, and accordingly an object thereof is to provide a longitudinal motion actuator having a configuration that enables speed reduction based on a reduction gear ratio flexibly responding to a required specification, and can obtain a high output with respect to the output of a motor.

Also, another object of the present invention is not only to make the parts and configuration of a plurality of transmission mechanisms common to construct a low-cost unit but also to achieve the reduction in tooth root stress to a pinion due to the provision of a speed reducing mechanism, the distribution of forces to the plurality of transmission mechanisms, and the reduction in radial load with respect to a motor bearing.

The longitudinal motion actuator in accordance with the present invention converts the rotation of a motor into longitudinal motion and outputs the motion. One pinion is fixed to a motor output shaft, and at least two sets of a plurality of transmission mechanisms having the same configuration are provided. Each of the transmission mechanisms is configured so that both ends of a lead screw to which a gear engaging with the pinion is fixed are rotatably supported by bearings. A movable nut provided with a plurality of threaded holes engaging with thread grooves in the lead screws of the transmission mechanisms is provided, and when the motor is rotated, the lead screws are rotated in the same direction via the pinion and the gear, by which the movable nut engaging with the lead screws is driven longitudinally.

Also, the transmission mechanisms can be arranged symmetrically around the pinion fixed to the motor output shaft. To the movable nut, an output wire or an output rod material connected with an external load at the tip end thereof is fixed.

According to the present invention, since the pinion is fixed to the motor output shaft, speed reduction can be accomplished on the transmission mechanism. Therefore, a high output can be obtained with respect to the motor output, and thereby a unit that has a smaller size and provides a higher output can be obtained.

Also, by changing the reduction gear ratio, the unit can flexibly respond to the required specification, and the characteristics of the motor itself can be made common. By providing the speed reducing mechanism, the tooth root stress to the pinion can be reduced. By providing the plurality of transmission mechanisms with respect to one pinion, the force can be distributed, so that radial loads to the motor bearing are cancelled. Further, since the plurality of transmission mechanisms are provided, by making the gears, lead screws, and radial bearings common, a low-cost unit can be constructed.

### BRIEF DESCRIPTION OF THE DRAWINGS

FIG. 1 is a partially sectioned view showing the general configuration of a longitudinal motion actuator embodying the present invention.

FIG. 2 is an explanatory view for explaining the relative positional relationship between a pinion and a gear.

FIG. 3A is an explanatory view for explaining power transmission in accordance with the present invention, and FIG. 3B is an explanatory view for explaining power transmission in accordance with a conventional art, being shown for comparison.

FIG. 4 is a schematic view showing the configuration of a conventional longitudinal motion actuator.

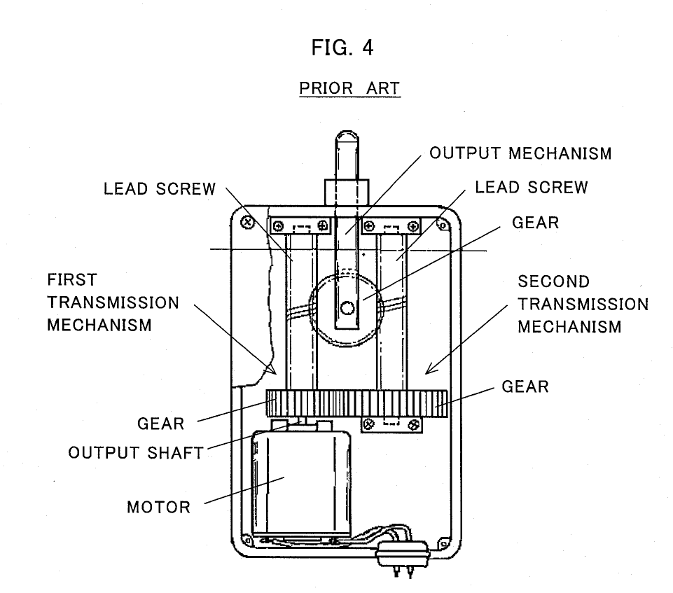

### DETAILED DESCRIPTION OF THE PREFERRED EMBODIMENTS

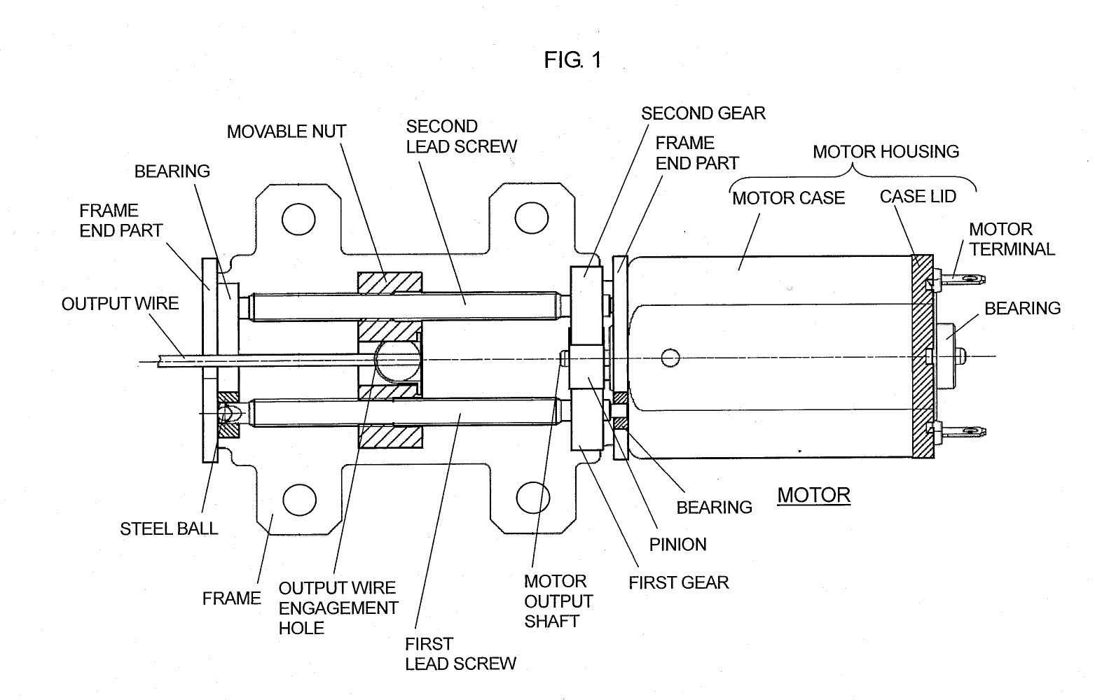

The present invention will now be described based on an example. FIG. 1 is a partially sectioned view showing the general configuration of a longitudinal motion actuator embodying the present invention. A motor itself shown in FIG. 1 is an ordinary one, and has a motor housing that is configured by fitting a case lid in the opening of a bottomed cylindrical motor case. In the motor housing, a stator and a rotor are housed. The shaft of the rotor is rotatably supported by bearings provided in the center of the bottom surface of the motor case and in the center of the motor lid. From the motor lid, a pair of motor terminals extend. By supplying electric power from the paired motor terminals, the motor is rotated.

The motor shown in FIG. 1 is fixed on a frame. From the center of the bottom part of the motor case, one end of the rotor shaft extends to the outside of motor through the end part of the frame as a motor output shaft, and a pinion is fixed on the motor output shaft by press fit etc.

On the other hand, first and second lead screws having the same configuration each are threaded in a spiral form excluding both end parts thereof. At one end of each of the first and second lead screws, first and second gears having the same configuration are fixed, respectively, by press fit etc. A movable nut engaging with the first and second lead screws is formed of a resin or a metal. In other words, the movable nut is formed with a total of two threaded holes engaging with the first and second lead screws. When the two lead screws shown in FIG. 1 are rotated in the same direction at the same rotational speed, the movable nut is longitudinally driven on the lead screws in the right or left direction in the figure according to the direction of rotation of the two lead screws. To the movable nut, an output wire or an output rod material connected with an external load to be driven longitudinally is fixed in an output wire engagement hole provided in the movable nut. Although the case where the two lead screws and threaded holes are provided has been explained as an example, generally, two or more lead screws can be used. In this case, the number of threaded holes is the same as the number of lead screws.

The first and second lead screws configured as described above are rotatably supported by bearings at both ends. In the example shown in FIG. 1, each bearing on one side (right-hand side in FIG. 1) of the first and second lead screws is supported on the frame end part, and the bearing on the other side (left-hand side in FIG. 1) is fixed to the frame end part.

As these bearings, any type of bearing having an ordinary configuration can be used. As the bearing on the left-hand side in FIG. 1, a bearing accommodating a steel ball positioned on the tip end side of the lead screw is typically shown. The steel ball supports a thrust load applied on the tip end side of the lead screw when an external load (not shown) is pulled and driven by the output wire. Alternatively, when the output rod material is used in place of the output wire to drive the external load in the pushing direction, the thrust load must be supported by the bearing provided in the frame end part on the motor side. Thus, either side of the lead screw must bear the load not only in the radial direction but also in the thrust direction according to the application of external load connected to the tip of the output wire or the output rod material.

In the longitudinal motion actuator, when the motor is rotated in a predetermined direction, the first and second gears are rotated in the same direction with respect to each other and in the direction opposite to the direction of rotation of the motor via a pinion fixed to the output shaft of the motor. Thereby, the first and second lead screws are rotated in the same direction with respect to each other, and move the movable nut, which engages with the lead screws, for example, to the motor side in FIG. 1. The output wire connected to the movable nut is pulled, by which the external load is driven. Next, when the motor rotation is reversed, the movable nut moves to the opposite side. The actuator is configured so that the output wire is pulled in the left direction in FIG. 1 at this time by using a spring (not shown) so that the output wire does not deflect.

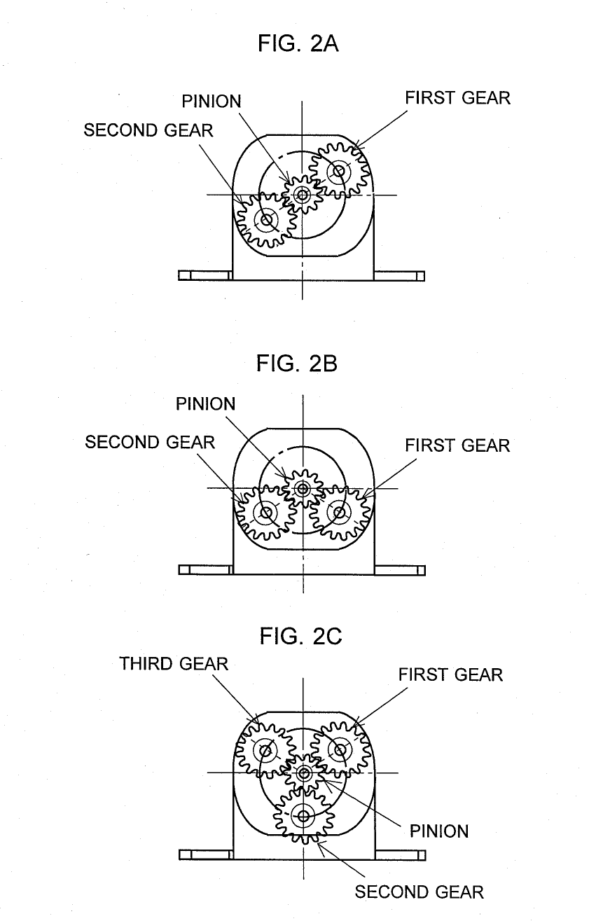

FIG. 2 is an explanatory view for explaining the relative positional relationship between the pinion and the gear. FIG. 2A shows an example in which two sets of transmission mechanisms each consisting of the gear and the pinion are used, and the transmission mechanisms and the motor output pinion are arranged on a straight line. The two first and second gears are arranged at positions on both sides opposed at an angle of 180° with the pinion being the center. Thereby, the radial loads applied to the transmission mechanisms are cancelled, by which long service life of the bearings etc. can be achieved. However, even if the two gears are not located at the positions opposed at an angle of 180° as shown in FIG. 2B, the radial loads can be cancelled to some degree. FIG. 2C shows an example in which three sets of transmission mechanisms are used. Three first to third gears shown in FIG. 2C are arranged at equal intervals (intervals of 120°) around the pinion. Thereby, the radial loads applied to the gear parts of transmission mechanisms are cancelled, by which long service life of the bearings etc. can be achieved.

In any case of FIGS. 2A to 2C as well, when the pinion fixed to the motor output shaft is rotated in either direction, all of the plurality of gears each having the same configuration, which engage with this pinion, are rotated in the same direction and in the direction opposite to the direction of rotation of the pinion.

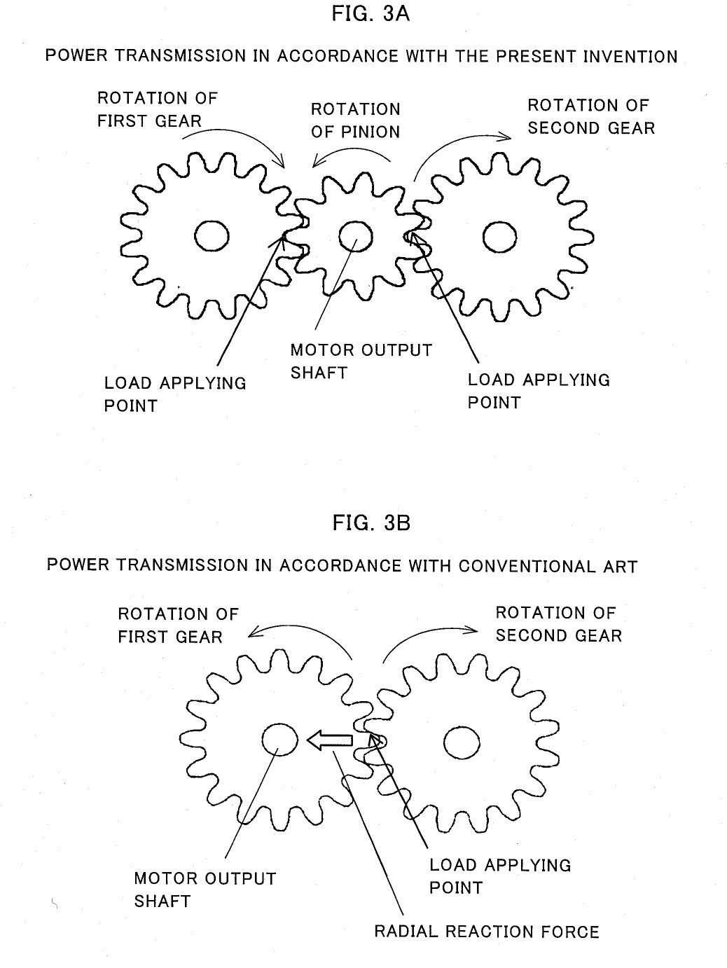

FIG. 3A is an explanatory view for explaining power transmission in accordance with the present invention, and FIG. 3B is an explanatory view for explaining power transmission in accordance with a conventional art, being shown for comparison. In the configuration of conventional art shown in FIG. 3B, a first gear is fixed to the motor output shaft, and a second gear engaging with this first gear is provided. Therefore, the construction is made such that at a load applying point at the position where the gears engage with each other, a reaction force to the force applied to the gear is produced, and this reaction force is applied transversely (in the radial direction) to the motor output shaft.

In contrast, the present invention has a configuration such that, as shown in FIG. 3A, the pinion is fixed to the motor output shaft, and the power is transmitted from the pinion to the lead screws via the first and second gears. At this time, the first and second gears and the lead screws are rotated in the same direction. Therefore, the first and second lead screws and gears can use the same parts, so that the equipment can be made common. In addition, by arranging both of the gears symmetrically with respect to the pinion, the reaction forces generated from the gears can be cancelled. In the configuration of the present invention, when the pinion fixed to the motor output shaft is rotated, both of the two gears engaging with the pinion are rotated in the direction opposite to the direction of rotation of the pinion. The load applying point from the pinion to the first and second gears is produced at symmetrical positions on both sides of the pinion, and the directions of the reaction forces are opposite to each other. Thereby, the radial loads on the motor bearing are cancelled into zero, so that the wear resistance of motor bearing can be improved.

Also, the configuration in accordance with the present invention is such that the speed reduction due to the pinion and the gear can be accomplished, and thereby a high output can be obtained. Therefore, this configuration has advantages of smaller size of unit including the motor and saving of electric power. Further, since the characteristics can be changed by changing the reduction gear ratio, the motor part can be standardized easily.

What is claimed is:

1. A longitudinal motion actuator which converts the rotation of a motor into longitudinal motion and outputs the motion, comprising:
one pinion fixed to a motor output shaft;
at least two sets of a plurality of transmission mechanisms having the same configuration;
each of the plurality of transmission mechanisms being configured so that both ends of a lead screw to which a gear engaging with the pinion is fixed are rotatably supported by bearings; and
a movable nut provided with a plurality of threaded holes engaging with thread grooves in the lead screws of the plurality of transmission mechanisms;
wherein the plurality of lead screws are rotated in the same direction via the pinion and the gear, by which the movable nut engaging with the plurality of lead screws is driven longitudinally, when the motor is rotated.

2. The longitudinal motion actuator according to claim 1, wherein the plurality of transmission mechanisms are arranged symmetrically around the pinion fixed to the motor output shaft.

3. The longitudinal motion actuator according to claim 1, wherein to the movable nut, an output wire or an output rod material connected with an external load at the tip end thereof is fixed.
